(19) United States
(12) Patent Application Publication
(10) Pub. No.: US 2025/0059796 A1
(43) Pub. Date: Feb. 20, 2025

(54) TENSION BOARD FOR STRAINING WIRE MESHES

(71) Applicant: WIREMAN PTY LIMITED, Milsons Point NSW (AU)

(72) Inventor: Ian Lowrey, Lane Cove West NSW (AU)

(21) Appl. No.: 18/798,093

(22) Filed: Aug. 8, 2024

(30) Foreign Application Priority Data
Aug. 15, 2023 (AU) 2023 902 588

(51) Int. Cl. E04H 17/02; B25B 25/00

(52) U.S. Cl. CPC E04H 17/127; B25B 25/00

(57) ABSTRACT

A tension board for straining wire mesh fences. The mesh has an apron that includes one or more longitudinal wires running substantially parallel to a fence and substantially in contact with the ground upon which the fence stands, and the tension board has a substantially L-shaped configuration. The tension board can take the form of a main board and an auxiliary board. The tension board can also include a bracing auxiliary board. The main board is adapted to strain the longitudinal wires of the fence and the auxiliary board is adapted to strain the longitudinal wires of the apron.

### FIELD OF THE INVENTION

The present invention relates to straining rural fences and, in particular, to straining wire mesh fences.

### BACKGROUND ART

Historically in Australia inclusion fences were intended to impound domestic stock such as cattle and sheep. Often cattle fences would be formed either from a number of plain wires, or from a number of barbed wires. Fences intended to impound sheep would generally incorporate sheep or rabbit netting which not only kept the sheep in, but kept feral rabbits out.

In more recent times mesh fencing such as that sold under the trade name HINGE LOCK has been produced and this is intended to be an all-purpose fence to impound all manner of domestic animals. The dimensions of the squares of the mesh vary according to whether the domestic animals are sheep or goats, cattle, or horses.

In still more recent times, the mesh fencing has been extended upwardly so as to transform the traditional waist high inclusion fence into a substantially head high exclusion fence intended to exclude animals such as kangaroos, deer and wild dogs.

The latest development in such exclusion fencing is to provide an apron which lies flat against the ground, and which is intended to provide protection against burrowing animals which may borrow underneath the fence, or non-burrowing animals which may utilise the tunnels or similar passageways created by burrowing animals. Such burrowing animals include wombats and wild pigs and such non-burrowing animals include kangaroos and deer.

### Genesis of the Invention

The genesis of the present invention arises from a desire to enable the longitudinally extending wires of the apron to be easily strained.

### SUMMARY OF THE INVENTION

In accordance with a first aspect of the present invention there is disclosed a tension board for straining wire mesh fences where the mesh has an apron comprising one or more longitudinal wires running substantially parallel to the fence and substantially in contact with the ground, the tension board having a substantially L-shaped configuration.

Preferably, the L-shaped configuration takes the form of a main board adapted to strain the longitudinal wires located above the ground, and an auxiliary board adapted to strain the longitudinal wires of the apron.

Preferably, the auxiliary board is releasably detachable from the main board.

### BRIEF DESCRIPTION OF THE DRAWINGS

A preferred embodiment of the invention will now be described, by way of example only, with reference to the accompanying drawings in which:

FIG. 1 is a side view of a fence showing a mesh having an apron,

FIG. 2 is a first perspective view of a first embodiment of a tension board having a main board and an auxiliary board, the auxiliary board being adapted to strain the apron of FIG. 1,

FIG. 3 is a second perspective view of the tension board of FIG. 2,

FIG. 4 is a perspective view of the auxiliary board of FIGS. 2 and 3,

FIG. 5 is an exploded perspective view of the auxiliary board of FIG. 4,

FIG. 6 is a first perspective view of a joining interconnector of a first embodiment which interconnects the auxiliary and main boards,

FIG. 7 is another perspective view of the joining interconnector of FIG. 6

FIG. 8 is a perspective view similar to FIG. 2 but illustrating a tension board of a second embodiment,

FIG. 9 is a perspective view similar to FIG. 3 but illustrating the tension board of FIG. 8,

FIG. 10 is a further perspective view of the tension board of FIG. 8,

FIG. 11 is a first perspective view of a joining interconnector of a second embodiment,

FIG. 12 is another perspective view of the joining interconnector of FIG. 11,

FIG. 13 is an exploded perspective view of a bracing auxiliary arm and the joining interconnector of FIGS. 11 and 12, and

FIG. 14 is an unexploded perspective view of the bracing auxiliary arm of FIG. 13 in position between two of the joining interconnectors of FIGS. 11 and 12.

### DETAILED DESCRIPTION

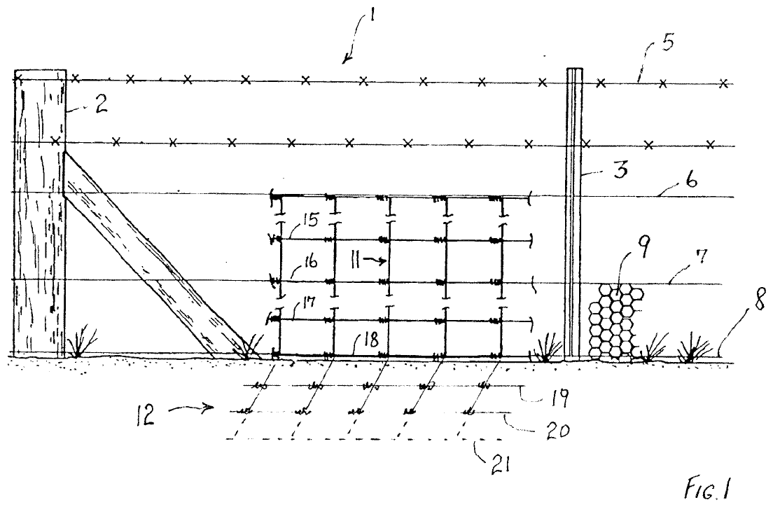

As seen in FIG. 1, a rural fence 1 has a strainer post 2 and a multiplicity of intermediate posts 3. Often the fence 1 has one or more strands of barbed wire 5 and a series of wires in the form of a top wire 6, a belly wire 7 and a ground wire 8. Historically sheep or rabbit netting, schematically illustrated at 9, was secured to the wires 6, 7 and 8.

In recent times the rabbit netting 9 has been replaced by a mesh 11 such as that sold under the trade name HINGE LOCK which was secured to the wires 6, 7 and 8. In still more recent times, the wires 6, 7 and 8 have been dispensed with and the mesh 11 thus is substantially self-supporting. In addition, the mesh 11 is provided with an apron 12 which consists of a portion of the mesh which is intended to be positioned in contact with the ground 13.

Thus, the mesh 11 with apron 12 consists of a plurality of longitudinal fence wires 15, 16, 17, etc. a ground wire 18, and typically two (or three) longitudinal apron wires 19, 20 (and 21 if present and indicated by dashed lines).

When it comes to straining the mesh 11, traditional tension boards can be used to simultaneously strain the fence wires 15, 16, 17 etc. and the ground wire 18. Such a tension board is disclosed in International Patent Application Nos WO 2020/176936 and WO2023/215934, the contents of both of which are incorporated herein for all purposes. However, it is not generally possible, or convenient, to connect the apron wires 19, 20, 21 to the traditional tension boards. As a result, the apron wires 19, 20, 21 are either not strained at all, or are only lightly strained, one at a time using a conventional hand strainer.

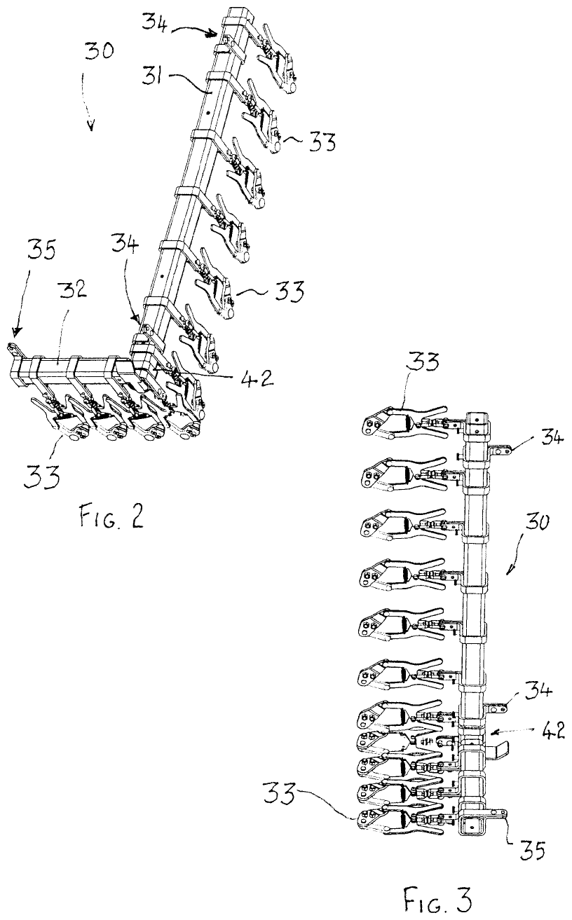

Turning now to FIG. 2, there is illustrated a new tension board 30 having an L-shaped configuration and being formed from a main board 31 and an auxiliary board 32, which is generally perpendicular to the main board 31. As seen in FIG. 2, the main board 31 is provided with eight wire grippers 33 such as those disclosed in International Patent Application No WO 2020/051630. In addition, the main board is provided with two yoke connection points 34 which enables a chain yoke, of V shape or similar, to be connected between the main board 31 and a straining mechanism such as a motor vehicle, hoist, come along, or the like.

In addition to the foregoing, the auxiliary board 32 also includes three wire grippers 33 and an additional yoke connection point 35.

As a consequence of the above arrangements, the longitudinal mesh wires 15, 16, 17, etc. can be connected to the grippers 33 of the main board 31, whilst the apron wires 19 and 20 (and 21 if present) can be connected to the grippers 33 of the auxiliary board 32. The ground wire 18 can be connected to a gripper 33 of either the main board 31 or the auxiliary board 32. This interconnection enables all the wires 15, 16, 17, 18, 19 and 20 (and 21) to be simultaneously strained using the main board and the auxiliary board together as a single tension board 30.

It is convenient to make the auxiliary board 32 releasably detachable from the main board 31 for reasons of ease of transport, and also to enable the main board 31 to be used as a conventional tension board in the event that a mesh 11 is being strained which does not have an apron 12. Under these circumstances there is no particular requirement for the auxiliary board 32.

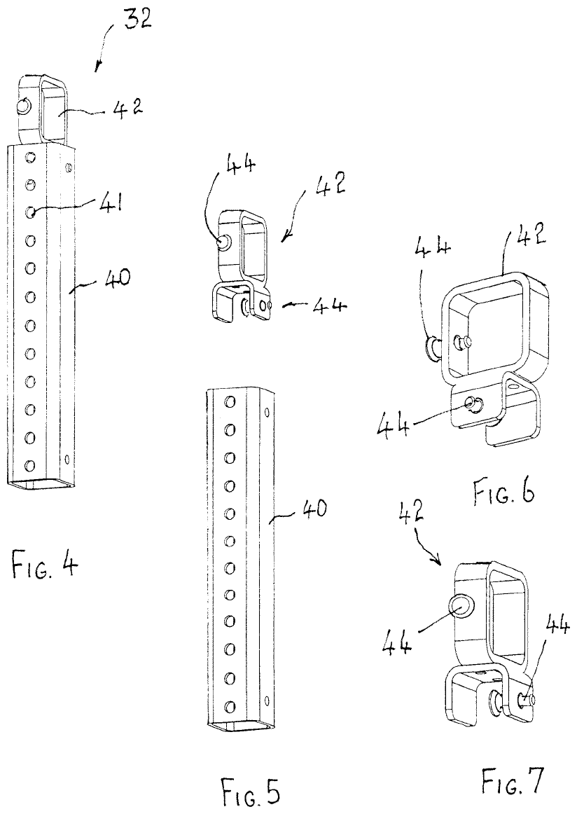

One way of making the auxiliary board 32 detachable from the main board 31 is illustrated in FIGS. 4-7. It will be seen that the auxiliary board 32 takes the form of a rolled hollow section (RHS) 40 which is provided with a multiplicity of apertures 41 along one side. An interconnector 42 is located at one end of the RHS 40 and is sized to mate with the main board 31 as illustrated in FIGS. 2 and 3. Preferably, spring biased plunger detents 44 are provided on the interconnector 42 to permit releasable interconnections between the interconnector 42, the main board 31 and the RHS 40.

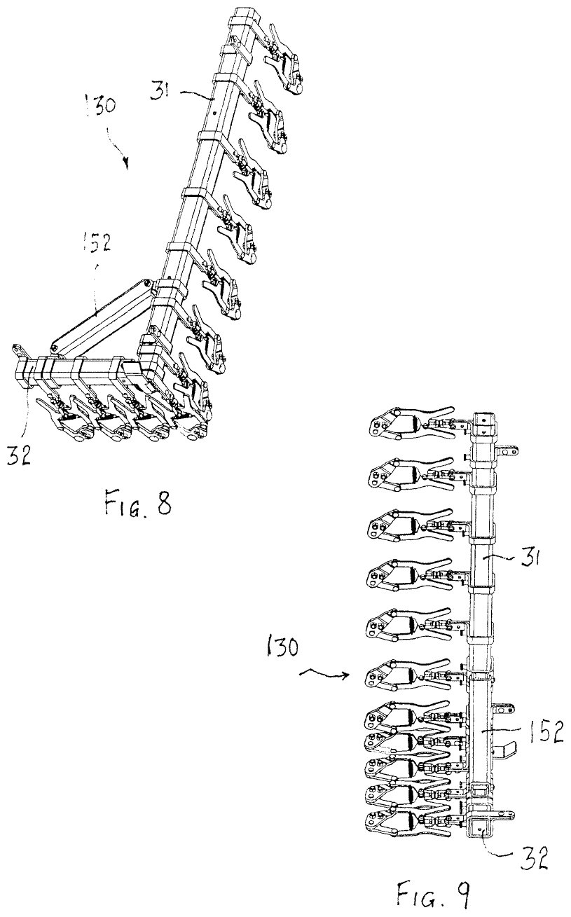

Turning now to FIGS. 8-10, a tension board 130 of a second embodiment is illustrated. The tension board 130 has a main board 31 and an auxiliary board 32 and wire grippers 33 as in the first embodiment. However, there is a bracing auxiliary board 152 which extends between the main board 31 and the auxiliary board 32 and provides a strengthening cross brace.

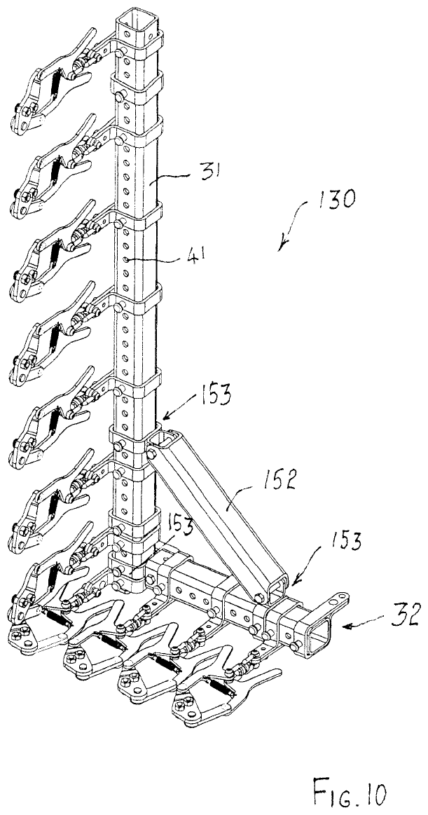

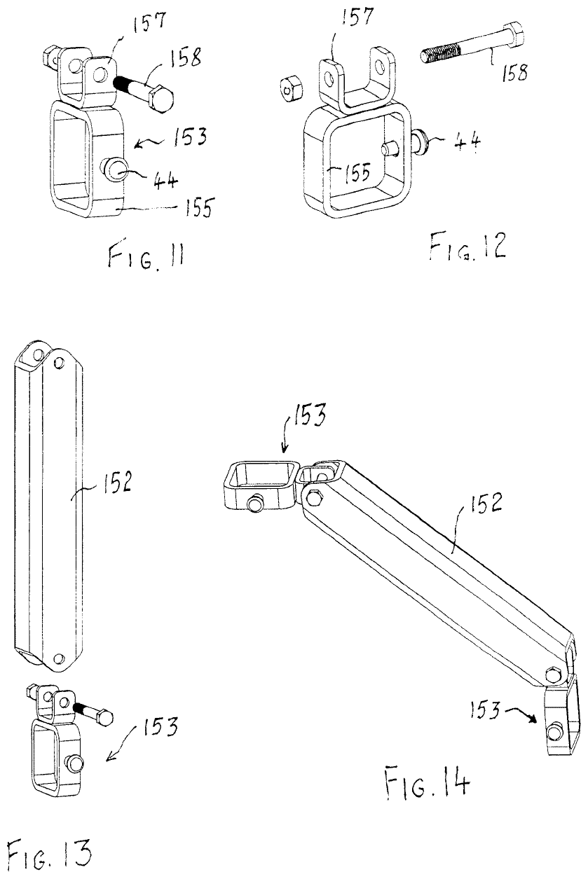

The bracing auxiliary board 152 has a pair of joining interconnectors 153 as best seen in situ in FIG. 10 and illustrated separately in FIGS. 11 and 12. Each of the joining interconnectors 153 has a rectangular saddle 155 with a plunger detent 44. Also mounted on the saddle 155 is a U-shaped yoke 157 which receives a bolt 158 together with its nut. The yoke 157 is shaped to be received within the bracing auxiliary board 152 with the bolt 158 forming an axle permitting rotation between the bracing auxiliary board 152 and the saddle 155.

As a consequence, as seen in FIG. 10, the two saddles 155 can be positioned in selected ones of the apertures 41 so as to set the angle between the main board 31 and the auxiliary board 32. Although a right angle is illustrated in FIGS. 8-10, the angle between the main board 31 and the auxiliary board 32 can differ substantially from a right angle in order to correspond to the ground conditions. Furthermore, the large number of closely spaced apertures 41 means that the bracing auxiliary board 152 need not be telescopic, or otherwise adjustable in length, in order to set the angle between the main board 31 and the auxiliary board 32.

A third joining interconnector 153 interconnects the main board 31 and the auxiliary board 32 so as to permit pivoting motion of the auxiliary board 32 relative to the main board 31.

It will be apparent to those skilled in the art that in some circumstances, the ground alongside the fence which is to receive the apron, slopes relative to the fence. As a consequence, it is desirable to set the auxiliary board 32 to approximately this angle in order to facilitate straining of the apron.

In addition, some fences, particularly exclusion fences, are now provided with cantilever arms or outriggers at the top of the fences. In the absence of an apron, either the tension board 30, or the tension board 130, can be used “upside down” to tension wires provided on the cantilever arms. Where both an apron and cantilever arms are provided, then two auxiliary boards 32 can be provided, one at each end of the tension board 30, 130, in order to simultaneously strain both the apron and the wires provided on the cantilever arms, in addition to straining the fencing wires.

The foregoing describes only some embodiments of the present invention and modifications, obvious to those skilled in the building arts, can be made thereto without departing from the scope of the present invention. For example, the apron wires 19-21 can be held down against lifting by use of the ground anchors disclosed in WO 2022/056581. The features and advantages disclosed to one facet of the invention may be utilised, mutatis mutandis, in other facets of the invention.

The term “comprising” (and its grammatical variations) as used herein is used in the inclusive sense of “including” or “having” and not in the exclusive sense of “consisting only of”.

1. A tension board for straining wire mesh fences where the mesh has an apron comprising one or more longitudinal wires running substantially parallel to the fence and substantially in contact with the ground, said tension board having a substantially L-shaped configuration.

2. The tension board as defined in claim 1 wherein said L-shaped configuration takes the form of a main board adapted to strain the longitudinal wires located above the ground, and an auxiliary board adapted to strain the longitudinal wires of said apron.

3. The tension board as defined in claim 2 wherein said auxiliary board is substantially perpendicular to said main board.

4. The tension board as defined in claim 2 wherein said auxiliary board is not substantially perpendicular to said main board.

5. The tension board as defined in claim 2 wherein said main board has a first plurality of wire grippers extending therefrom, and said auxiliary board has a second plurality of wire grippers extending therefrom, the number of said first plurality exceeding the number of said second plurality.

6. The tension board as defined in claim 2 wherein said auxiliary board is releasably detachable from said main board.

7. The tension board as defined in claim 2 wherein said main board and said auxiliary board have substantially the same transverse cross-sectional shape.

8. The tension board as defined claim 2 and having a bracing auxiliary board extending between said main board and said auxiliary board.

9. The tension board as defined in claim 8 wherein said bracing auxiliary board is adjustable.

10. The tension board as defined in claim 2 and having an auxiliary board located at either one of two opposite ends of said main board.
